(19) United States
(12) Patent Application Publication
(10) Pub. No.: US 2005/0268679 A1
(43) Pub. Date: Dec. 8, 2005

(54) Agrochemical composition containing phosphite and process for the preparation thereof

(76) Inventor: Alexander Josef, Ared (IL)

Correspondence Address: GOTTLIEB RACKMAN & REISMAN PC, 270 MADISON AVENUE, 8TH FLOOR, NEW YORK, NY, 100160601, US

(21) Appl. No.: 10/521,985

(22) PCT Filed: Jul. 25, 2003
(86) PCT No.: PCT/IL03/00620

§ 371 Date: Jul. 19, 2005

(30) Foreign Application Priority Data
Jul. 25, 2002 (IL) 150910

(51) Int. Cl. C05C 1/00

(52) U.S. Cl. 71/31

(57) ABSTRACT

An agrochemical composition having both fertilizing and pesticidal properties is described. The granular composition, containing phosphite, at least one other NPK nutrient, and metal microelements, is homogeneous in the chemical composition, uniform in particle size, and water-soluble. A process for the manufacture of the agrochemical composition is also described.

### FIELD OF THE INVENTION

This invention relates to a solid, granular and uniform in the particle size, free flowing, water-soluble, agrochemical composition, containing phosphate and being homogeneous in the chemical composition, that contains at least one other NPK nutrient, and comprises metal microelements.

### BACKGROUND OF THE INVENTION

An ideal agrochemical composition would provide all elements necessary for the plant growth, it would provide some protection against pests, and it would not leave harmful or useless deposits in the soil. Such composition should be further easy for storage, manipulation, usage, and marketing. From the aforesaid results that an ideal composition should be solid, particulate but not dusty, and water-soluble.

Phosphites are used in agrochemical compositions as a phosphorus source and for their pesticidal potential. Publication WO 00/76941 claims potassium phosphites as a fertilizer for trees, vines and crops. U.S. Pat. No. 5,514,200 teaches that phosphite fertilizers inhibit the beneficial symbiosis between plant roots and mycorrhizal fungi, and further promote bacterial and fungicidal growth. The U.S. Pat. No. 5,830,255 discloses a concentrated buffered phosphorus fertilizer comprising a phosphorous salt or acid, and possibly other nutrients. Fertilizer compositions for plants containing phosphite (PO₃⁻³) and phosphate (PO₄⁻³) salts are disclosed in U.S. Pat. No. 5,800,837, and antifungal compositions containing phosphite and phosphate salts are disclosed in WO 01/28334. U.S. Pat. No. 5,736,164 relates to a composition which contains phosphite and phosphate salts and derivatives thereof for controlling parasitic fungi, and U.S. Pat. No. 4,119,724 discloses fungicidal compositions containing phosphorous acid and inorganic and organic salts, as well as a method for their application to plants for controlling fungus disease.

It is desirable to provide a phosphite containing agrochemical composition that would also posses the above mentioned advantageous physical properties. It is therefore an object of this invention to provide an agrochemical composition that is solid, granular and uniform in the particle size, and water-soluble, contains phosphite and is homogeneous in the chemical composition, which composition contains at least one other NPK nutrient (nitrogen and/or phosphorus and/or potassium containing nutrient), and comprises metal microelements.

It is a further object of this invention to provide a process for manufacturing said agrochemical composition.

Other objects and advantages of present invention will appear as description proceeds.

### SUMMARY OF THE INVENTION

This invention provides an agrochemical composition that is solid, granular and uniform in particle size, free flowing, and water-soluble, and contains phosphite and is homogeneous in the chemical composition, which composition contains at least one other NPK nutrient, and comprises metal microelements. The invention provides a process for manufacturing said agrochemical composition, which process is characterized in that it comprises i) blending and heating at a temperature from 60° C. to 130° C. a mixture containing phosphorous acid, at least one other NPK nutrient, metal microelements and other additives enhancing its fertilizing and pesticidal properties or modifying functional or aesthetic properties of the particles; ii) introducing a base into the mixture, thus at least partially neutralizing phosphorous acid, wherein the amount of the base is sufficient to provide that the pH of a 1% water solution of the final composition will be between 3.4 and 7.0; iii) homogenizing the mixture, while optionally lowering the pressure above the mixture; iv) and cooling the mixture, while obtaining a homogeneous, granular, free flowing and not caking material, with low hygroscopicity, containing from 0% to 1% water.

### DETAILED DESCRIPTION OF THE INVENTION

It has now been found that phosphite salts, NPK nutrients, and metal microelements can be combined in a homogeneous agrochemical composition that has a consistency of solid, granular and particle-size uniform, and water-soluble material. The present invention provides a process for obtaining such composition comprising i) blending and heating a mixture containing phosphorous acid, at least one NPK nutrient, and metal microelements and other additives; ii) introducing a base into the mixture, thus partially neutralizing phosphorous acid, wherein the amount of the base is sufficient to provide that the pH of a 1% water solution of the final composition will be between 3.4 and 7.0; iii) homogenizing the mixture, and optionally lowering the pressure above the mixture; iv) and cooling the mixture, breaking it up, and obtaining a dry, granular, homogeneous material.

The components may be added to the mixture, or may be preheated, in any order. However, the complete mixture must be heated at a temperature between 60° C. and 130° C., becoming molten and enabling good homogenization. In one embodiment, all the components are blended and preheated in a reactor to 100° C., followed by adding solid phosphorous acid into the mixture, incubating the mixture until a paste is obtained, and homogenizing the mixture when the viscosity decreases. In another embodiment, phosphorous acid is first heated at a temperature higher than 60° C., and all other ingredients are then added to the molten acid.

The NPK nutrient is preferably chosen from the group consisting of monoammonium phosphate, monopotassium phosphate, dipotassium phosphate, sodium nitrate, potassium chloride, ammonium chloride, potassium sulfate, ammonium sulfate, and urea. The metal microelements are preferably chosen from the group consisting of zinc, copper; iron, manganese, molybdenum, and boron, and can be added as a compound contained in any commercially available material. Metals can be present as cations in salts such as chloride, nitrate, sulfate; as anions such as molybdate; as chelates such as ethylenediamine tetraacetate, or other, such as boric acid.

The ratios between phosphorous, other NPK nutrients, and the micronutrients, are determined according to their required relative content in the final product.

The amount of phosphorous acid in the mixture according to this invention is from 10 to 95 wt %, the amount of other NPK nutrients is between 5 to 90 wt %, and the amount of microelements is from 0.005 wt % to 2 wt %. In a preferred embodiment of this invention, monoammonium phosphate (MAP) and monopotassium phosphate (MKP) are used as other NPK nutrients. In one embodiment MAP, MKP and phosphorous acid are used in ratios 1:2:1. In another embodiment only MKP as another NPK nutrient beside phosphorous acid is used, wherein the ratio MUP to phosphorous is 3:1.

The molten mixture is at least partially neutralized by a base, wherein the amount of the base is chosen as to ensure a pH from 3.4 to 7.0 for the final product in 1% water solution. This pH is optimal from viewpoint of i) the hygroscopicity of the final composition, ii) the solubility of the composition, and iii) the fertilizing and pesticidal effect of the composition during its use. Said pH confers the composition according to this invention a relatively low hygroscopicity, as expressed by the critical relative humidity, which is typically from 50% to 65%, and more typically from 55% to 60%.

In a preferred embodiment of this invention, a base MR is chosen from carbonates and hydroxides, wherein M is selected from K⁺, NH₄⁺ and R is selected from CO₃⁻² and OH⁻. In a still more preferred embodiment, the base comprises potassium carbonate or potassium hydroxide. In some embodiments of this invention, the neutralization reaction can be summarized as:
H₃PO₃+K₂CO₃→KH₂PO₃+H₂O+CO₂

During the neutralization, the temperature can increase due to the release of the neutralization heat, aiding the homogenization process. The homogenization of the molten mixture is eventually accompanied by formation of water and/or carbon dioxide inside the viscose material, and by their escape to the gas phase. In a preferred arrangements of the process according to this invention, the pressure above the molten mixture is lowered, which accelerates removal of water from the mixture.

In a preferred embodiment of this invention, the molten mixture before the neutralization is heated at a temperature 61° C. to 100° C. In another embodiment according to this invention, the pressure above the molten mixture is lowered below 70 mm Hg, and preferably below 40 mm Hg.

The homogeneous molten mixture is finally cooled, and broken up. The consistency of the cooled material enables to obtain a granular, free flowing, material with uniform grain-size by using methods known in the art. The particles contain typically less than 1 wt % water, and more typically from 0.1 to 0.4 wt % water.

An agrochemical composition according to this invention is completely dissolved when mixing 10 parts of the composition with 90 parts of water at an ambient temperature. Said composition provides pH from 3.4 to 7.0, and more typically pH from 3.8 to 5.3, when dissolved 1 part in 100 parts of water. A typical composition of this invention dissolves completely even in the ratio of 20 parts per 80 parts of water, when mixed at ambient temperatures.

An agrochemical composition according to this invention may additionally contain additives that further enhance its fertilizing and pesticidal properties, such as humic acid, or that modify functional or aesthetic properties of the particles finally obtained, such as surfactants or dyes.

The invention will be further described and illustrated in the following examples.

### EXAMPLES

### Materials

Monopotassium phosphate and monoammonium phosphate, used here, are products of Rotern Amfert Negev Ltd., Israel

### General Procedures

The samples of granular compositions were prepared in either of two stirred reactors, equipped with heating and cooling mantle, having volumes 1 and 5 liters, respectively. The smaller one was a glass reactor, and the bigger one a steel reactor equipped with a condenser, and connected to a vacuum pump. The solubility of the samples was characterized by mixing 10 gram in 90 ml distilled water at room temperature for 1 hour. A 1% solution was used for pH measurements. The water content of compositions was determined using Mettler balance adopted for humidity measurements. The hygroscopicity was characterized as the critical relative humidity, as per T.V.A. standard. Shortly, this method determines a relative humidity of an environment in which water absorption by the sample causes a mass increase higher than 3%. The size distribution was characterized by measuring mass fraction of the particles having size less than 0.25 mm, between 0.25 and 1.4 mm, and more than 1.4 mm.

### Example 1

A molten mixture was prepared in the glass reactor by mixing 80 g monopotassium phosphate (MKP) and 20 g phosphorous acid (PA). The mixture was heated, and the melting started at temperature 62° C. The molten mixture was neutralized by 20.8 g potassium carbonate, and the temperature reached 106° C. The molten mixture was cooled by feeding it to a cool medium, and crushed. A granular product was obtained, characterized by pH 3.8 in the 1% solution, and hygroscopicity expressed by the the critical relative humidity of 60-65%.

### Example 2

A molten mixture was prepared as in example 1 by mixing 80 g MKP and 20 g PA. The mixture was heated, and the melting started at temperature 62° C. The molten mixture was neutralized by 21.2 g potassium carbonate, and the temperature reached 120° C. The molten mixture was cooled by feeding it to a cool medium, and crushed. A granular product was obtained, characterized by the pH 4.4 in 1% solution, and the hygroscopicity expressed by the critical relative humidity of 55-60%.

### Example 3

A molten mixture was prepared as in example 1 by mixing 80 g MKP and 20 g PA. The mixture was heated, and the melting started at temperature 62° C. The molten mixture was neutralized by 22.8 g potassium carbonate, and the temperature reached 106° C. The molten mixture was cooled by feeding it to a cool medium, and crushed. A granular product was obtained, characterized by pH 5.0 in 1% solution, and hygroscopicity expressed by the critical relative humidity of 50-55%.

### Example 4

A mixture containing 66 g MKP, 21.5 g PA, and micronutrients comprising 2.0 g Mg EDTA and 0.5 g Mn EDTA, was heated in a glass reactor, and the melting started at temperature 62° C. The molten mixture was neutralized by 18.7 g potassium carbonate, and the temperature reached 140° C. The molten mixture was cooled by feeding it to a cool medium, and crushed. A granular product was obtained, characterized by pH 4.2 in 1% solution, and hygroscopicity expressed by the critical relative humidity of 55-60%.

### Example 5

A mixture containing 66 g MKP, 21.5 g PA, and micronutrients comprising 2.0 g Mg EDTA and 0.5 g Mn EDTA, was heated in a glass reactor, and the melting started at temperature 62° C. The molten mixture was neutralized by 13.1 g potassium carbonate, and the temperature reached 130° C. The molten mixture was cooled by feeding it to a cool medium, and crushed. A granular product was obtained, characterized by pH 3.4 in 1% solution, and hygroscopicity expressed by the critical relative humidity of 55-60%.

### Example 6

A homogeneous blend of 252.9 g monoamonium phosphate (MAP), 497.5 g monopotassium phosphate (MKP), 3.98 g Zn EDTA, and 2.03 g Cu EDTA is was placed in the steel reactor, heated to 100° C., and stirred for 10 minutes, followed by adding 205.4 g of solid phosphorous acid (PA). The mixture acquired a consistency of paste, the viscosity of which decreased with time. After 10 minutes 278.8 g of potassium carbonate was added to the reactor, followed by release of heat, water and carbon dioxide, and decrease of the viscosity. Stirring continued for 5 minutes. The mixture was perfectly homogeneous. In order to increase the intensity of drying after the sufficient homogenization, the vacuum pump was activated for 15 minutes, lowering the pressure to about 30 mm Hg. The crushed material was then cooled. About 883 g of a granular, free flowing composition was obtained, having 72.8% mass in the preferred size range of 0.25-1.4 mm, with 6.5% being smaller and 20.7% bigger. The water content of the composition was 0.44%, the pH of its 1% solution was 5.3, and its hygroscopicity as expressed by the critical relative humidity was 55-60%. No caking was observed.

### Example 7

A homogeneous blend of 168.6 g MAP, 331.7 g MK, 2.65 g Zn EDTA, and 1.35 g Cu EDTA was placed in the steel reactor, heated to 100° C., and stirred for 10 minutes, followed by the addition of 137 g of solid PA. The mixture acquired a consistency of paste, the viscosity of which decreased with time. After 10 minutes 172.5 g of potassium carbonate was added to the reactor, followed by release of heat, water and carbon dioxide, and decrease of the viscosity. Stirring continued for 5 minutes. The mixture was perfectly homogeneous. The vacuum pump was activated for 30 minutes, lowering the pressure to about 30 mm Hg. The material was then cooled, and crushed. About 631 g of a granular, free flowing, composition was obtained, having 74.8%; mass in the preferred size range of 0.25-1.4 mm, with 1.4% being smaller and 23.8% bigger. The water content of the composition was 0.17%, the pH of its 1% solution was 5.1, and its hygroscopicity, as expressed by the critical relative humidity, was 55%. No caking was observed.

### Example 8

A homogeneous blend of 168.6 g MAP, 331.7 g MKP, 2.65 g Zn EDTA 1.35 g Cu EDTA, and 7.9 g humic acid was placed in the steel reactor, heated to 100° C., and stirred for 10 minutes, followed by the addition of 137 g of solid PA. The mixture acquired a consistency of paste, the viscosity of which decreased with time. After 10 minutes 172.5 g of potassium carbonate was added to the reactor, followed by release of heat, water and carbon dioxide, and decrease of the viscosity. Stirring continued for 5 minutes. The mixture was perfectly homogeneous. The vacuum pump was activated for 14 minutes, lowering the pressure to about 30 mm Hg. The material was then cooled and crushed. About 630 g of a granular, free flowing, composition was obtained, having 62.6% mass in the preferred size range of 0.25-1.4 mm, with 11.2% being smaller and 26.2% bigger. The water content of the composition was 0.23%, the pH of its 1% solution was 5.0, and its hygroscopicity, as expressed by the critical relative humidity, was 55%. No caking was observed.

### Example 9

A homogeneous blend of 168.6 g MAP, 331.7 g MKP, 2.65 g Zn EDTA 1.35 g Cu EDTA, and 20 g of stimulator Fertivant was placed in the steel reactor, heated to 100° C., and stirred for 10 minutes, followed by the addition of 137 g of solid PA. The mixture acquired a consistency of paste, the viscosity of which decreased with time. After 10 minutes 172.5 g of potassium carbonate was added to the reactor, followed by release of heat, water and carbon dioxide, and decrease of the viscosity. Stirring continued for 5 minutes. The mixture was perfectly homogeneous. The vacuum pump was activated for 23 minutes, lowering the pressure to about 30 mm Hg. The material was then cooled and crushed. About 620 g of a granular, free flowing, composition was obtained, having 81.0% mass in the preferred size range of 0.25-1.4 mm, with 2.5% being smaller and 16.5% bigger. The water content of the composition was 0.31%, the pH of its 1% solution was 4.8, and its hygroscopity, as expressed by the critical relative humidity was 55%. No caking was observed.

### Example 10

A homogeneous blend of 168.6 g MAP, 331.7 g MD, 2.65 g Zn EDTA, AND 1.35 g Cu EDTA, was placed in the steel reactor, heated to 100° C., and stirred for 10 minutes, followed by the addition of 137 g of solid PA. The mixture acquired a consistency of paste, the viscosity of which decreased with time. After 10 minutes 292.2 g of 48% potassium hydroxide was added to the reactor. Stirring continued for 5 minutes. The mixture was perfectly homogeneous. The vacuum pump was activated for 45 minutes, lowering the pressure gradually to about 30 mm Hg. The mixture was then cooled and crushed. About 600 g of a granular, free flowing, composition was obtained, having 90.7% mass in the preferred size range of 0.25-1.4 mm, with 0.6% being smaller and 8.7% bigger. The water content of the composition was 0.36%, the pH of its 1% solution was 5.0, and its hygroscopity as expressed by the critical relative humidity was 55%. No caking was observed.

### Example 11

A homogeneous blend of 168.6 g MAP, 331.7 g MKP, 2.65 g Zn EDTA, 1.35 g Cu EDTA, and 100 mg of the violet dye Rhodamine was placed in the steel reactor, heated to 100° C., and stirred for 10 minutes, followed by the addition of 137 g of solid-PA. The mixture acquired a consistency of paste, the viscosity of which decreased with time. After 10 minutes 172.5 g of potassium carbonate was added to the reactor, followed by release of heat, water and carbon dioxide, and decrease of the viscosity. Stirring continued for 5 minutes. The mixture was perfectly homogeneous. The vacuum pump was activated for 22 minutes, lowering the pressure to about 30 mm Hg. The homogeneously violet material was then cooled and crushed. A granular, free flowing, composition was obtained, having the water content 0.47%, pH 4.4 in 1% solution, and hygroscopity 55%, as expressed by the critical relative humidity.

All the above has been provided for the purpose of illustration and is not intended to limit the invention in any way, except as defined in the claims to follow. Many modifications can be effected in the materials and methods described above, without exceeding the scope of the invention.

1. A solid, granular, free flowing, agrochemical composition containing a salt of phosphorous acid and at least one other NPK nutrient, that is homogeneous in the chemical composition and uniform in particle size, that is water-soluble, and that comprises metal microelements.

2. An agrochemical composition of claim 1, wherein at least one of the nutrient is chosen from the group consisting of monoammonium phosphate, monopotassium phosphate, dipotassium phosphate, potassium chloride, ammonium chloride, potassium sulfate, ammonium sulfate, and urea.

3. An agrochemical composition according to claim 1, wherein the salt of phosphorous acid is chosen from potassium salt, ammonium salt, and sodium salt.

4. An agrochemical composition according to claim 1, wherein at least one of the metal microelements is chosen from the group consisting of zinc, copper, iron, manganese, molybdenum, and boron.

5. An agrochemical composition according to claim 1, wherein the metal microelements are present as any commercially available salt.

6. An agrochemical composition according to claim 1, wherein the metal microelements are present in the form chosen from the group consisting of chloride, sulfate, molybdate, ethylenediaminetetraacetate, and boric acid.

7. An agrochemical composition according to claim 1, wherein the microelements act synergistically with salts of phosphorous acid.

8. An agrochemical composition according to claim 1, said composition additionally containing one or more additives that further enhance its fertilizing and pesticidal properties.

9. An agrochemical composition of claim 8, wherein the additive is chosen from the group consisting of stimulant, pesticide, and surfactant.

10. An agrochemical composition of claim 8, wherein the additive is humic acid.

11. An agrochemical composition of claim 8, wherein the additive acts synergistically with salts of phosphorous acid.

12. An agrochemical composition according to claim 1, additionally containing one or more additives that modify functional or aesthetic properties of the particles.

13. An agrochemical composition of claim 12, wherein the additive is chosen from the group consisting of surfactant and dye.

14. An agrochemical composition according to claim 1, wherein the NPK nutrient, other than a salt of phosphorous acid, comprises monoammonium phosphate or monopotassium phosphate.

15. An agrochemical composition according to claim 1, said composition containing from 10 to 95 wt % salts of phosphorous acid.

16. An agrochemical according to claim 1, said composition containing from 5 to 90 wt % of NPK nutrients, other than salts of phosphorous acid.

17. An agrochemical composition according to claim 1, said composition being completely dissolved when mixed with water at ambient temperatures, in the ratio of 10 parts of the solid to 90 parts of water.

18. An agrochemical composition according to claim 1, said composition being completely dissolved when mixed with water at ambient temperature, in the ratio 20 parts of the solid to 80 parts of water.

19. An agrochemical composition according to claim 1, said composition resulting in a solution having pH 3.4-7.0, when dissolved 1 part in 100 parts of water.

20. An agrochemical composition of any one of claims 1 to 19, said composition containing from 0% to 1% water.

21. An agrochemical composition according to claim 1, said composition containing from 0.1 to 0.4 wt % water.

22. An agrochemical composition according to claim 1, said composition containing from 0.005 wt % to 2 wt % microelements.

23. An agrochemical composition according to claim 1, said composition containing from 15 to 35 wt % salts of phosphorous acid.

24. An agrochemical composition according to claim 1, said composition containing from 65 to 85 wt % of NPK nutrients, other than salts of phosphorous acid.

25. An agrochemical composition according to claim 1, said composition containing from 0.05 wt % to 0.5 wt % microelements.

26. An agrochemical composition of any one of claims 1 to 25 according to claim 1, said composition resulting in a solution having pH 3.8-5.3, when dissolved 1 part in 100 parts of water.

27. An agrochemical composition according to claim 1, said composition is a free flowing, solid particles, composition.

28. A process for the manufacture of an agrochemical composition, said process comprising i) blending and heating at a temperature from 60° C. to 130° C. a mixture containing phosphorous acid, at least one other NPK nutrient, metal microelements and other additives; ii) introducing a base into the mixture, thus at least partially neutralizing phosphorous acid, wherein the amount of the base is sufficient to provide that the pH of a 1% water solution of the final composition will be between 3.4 and 7.0; iii) homogenizing the mixture, while optionally lowering the pressure above the mixture; iv) and cooling the mixture, while obtaining a homogeneous, granular, free flowing and not caking material, containing from 0% to 1% water.

29. A process according to claim 28, wherein the molten mixture is neutralized by a base of formula MR, wherein M is selected from potassium and ammonium, and R is selected from carbonate and hydroxide.

30. A process according to claim 28, wherein the molten mixture is neutralized by potassium carbonate or potassium hydroxide.

31. A process according to claim 28, wherein the components may be added to the mixture in any order.

32. A process according to claim 28, wherein the components may be preheated in any order before forming the complete mixture.

33. A process according to claim 28, wherein the complete mixture has a temperature between 60° C. and 130° C.

34. A process according to claim 28, said process further comprising a molten mixture.

35. A process according to claim 28, wherein the complete mixture is heated to a temperature between 61° C. and 100° C.

36. A process according to claim 28, said process yielding a granular composition homogeneous in chemical composition and uniform in particle-size.

37. A process according to claim 28, said process yielding a granular, free flowing composition that contains from 0.1% to 0.4% water.

38. A process according to claim 28, said process yielding a granular composition having hygroscopicity, as expressed by the critical relative humidity, from 50% to 65%.

39. A process according to claim 28, wherein the pressure is lowered below 70 mm Hg.
